(19) United States
(12) Patent Application Publication
(10) Pub. No.: US 2014/0247401 A1
(43) Pub. Date: Sep. 4, 2014

(54) SINGLE ELECTRODE LAYERED CAPACITIVE TOUCH-CONTROL DEVICE AND PANEL MODULE THEREOF

(71) Applicant: ILI TECHNOLOGY CORP., JHUBEI CITY (TW)

(72) Inventors: PEI-YU LEE, HSINCHU CITY (TW); HANG-KAI CHEN, TAICHUNG CITY (TW)

(73) Assignee: ILI TECHNOLOGY CORP., JHUBEI CITY (TW)

(21) Appl. No.: 13/903,025

(22) Filed: May 28, 2013

(30) Foreign Application Priority Data
Mar. 1, 2013 (TW) 102107323

(51) Int. Cl. G06F 3/044

(52) U.S. Cl. CPC G06F 3/044
USPC 349/12

(57) ABSTRACT

A panel module includes a substrate and a transparent electrode layer disposed on the substrate. The inner surface of the substrate has a plurality of touch-control segments. The transparent electrode layer of each touch-control segment has a coupling electrode, a plurality of first electrodes, and a plurality of second electrodes, wherein the coupling electrode, the first electrodes, and the second electrodes are arranged in an interval and insulting with each other. Each coupling electrode is separating the corresponding touch-control segment into a first-side region and a second-side region, wherein the first-side region and the second-side region are arranged on two opposite sides of the coupling electrode, the first electrodes are disposed on the first-side region, and the second electrodes are disposed on the second-side region. A portion of the transparent electrode layer disposed on any two adjacent touch-control segments are configured in a mirror symmetry arrangement.

### BACKGROUND OF THE INVENTION

1. Field of the Invention

The instant disclosure relates to a touch-control device; more particularly, to a single electrode layered capacitive touch-control device and a panel module thereof.

2. Description of Related Art

With the advancement of technology, the electronic information products not only progress toward a direction of being lighter and thinner, but also provide a friendlier human-machine interface so as to bring the convenience for the user. The human-machine interface includes an output interface and an input interface and the human-machine interface acts as a bridge between the user and electronic information product. The liquid crystal panel possesses some advantages, such as slim and light, such that it is easy for user to carry the liquid crystal panel, and the liquid crystal panel gradually replaces the cathode ray tube (CRT) commonly used for traditional output interface. With the use of liquid crystal panel, the input interface of traditional human-machine interface, such as a mouse and a keyboard, is replaced with a touch-control panel.

The capacitive touch-control panel is widely applied in the electronic information product due to the advantage of positioning precisely. The capacitive touch-control panel includes a plurality of sensing units arranged in array manner and a sensing chip electrically connected to the sensing units, where the sensing chip is used for sensing a touch-input status on the capacitive touch-control panel. A plurality of signal detecting lines are connected to each row or each column of the sensing units, and each of the plurality of signal detecting lines is connected to one end of the corresponding sensing unit located on each row or each column. When a finger touches any sensing unit, the touched sensing unit may generate a potential variation due to the effect of field coupling, and the sensing chip may acquire at least a touched location on the touch-control panel through detecting variation amounts of detecting signals transmitted by the signal detecting lines.

Moreover, the conventional capacitive touch-control device has a single electrode layer type, which is widely applied. However, conventional single electrode layered capacitive touch-control device has some problems. Please refer to FIG. 1, which shows the conventional single electrode layered capacitive touch-control device 1000′ including a panel module 100′ and a circuit module 200′. The panel module 100′ has a substrate 1′ and a transparent electrode layer 2′ disposed on the substrate V. The transparent electrode layer 2′ has a plurality of identical driving electrodes 21′ and a plurality of sensing electrodes 22′ respectively corresponding to the driving electrodes 21′. Each driving electrodes 21′ has a notch, and the notches of the driving electrodes 21′ are facing to the same direction (e.g., the right side toward the left side as shown in FIG. 1). Moreover, the sensing electrodes 22′ are arranged on the ipsilateral side of the corresponding driving electrodes 21′ (e.g., the left side of the driving electrodes 21′ as shown in FIG. 1. The circuit module 200′ has a plurality of driving lines 201′, a plurality of conductive lines 202′, a hub circuit 203′, and a touch-control circuit 204′. The driving electrodes 21′ are electrically connecting to the hub circuit 203′ via the driving lines 201′ respectively, and the sensing electrodes 22′ are electrically connecting to the hub circuit 203′ via the conductive lines 202′ respectively. The hub circuit 203′ is electrically connecting to the touch-control circuit 204′.

Due to the structural arrangement of the driving electrodes 21′ and the sensing electrodes 22′, only one of two opposite side edge of the substrate 1′ (e.g., the left-side edge as shown in FIG. 1) is used to host the conductive lines 202′. In other words, the conductive lines 202′, which are connected to the sensing electrodes 22′ arranged at the left-most side, are disposed on the left-most portion of the substrate 1′, while there is no conductive lines 202′ to be disposed on the right-most portion of the substrate V. The distribution of the conductive lines 202′ with respective to the substrate 1′ is not uniform, so that the edge portion of the conventional single electrode layered capacitive touch-control device 1000′ has bad touch accuracy.

To achieve the abovementioned improvement, the inventors strive via industrial experience and academic research to present the instant disclosure, which can provide additional improvement as mentioned above.

### SUMMARY OF THE INVENTION

One embodiment of the instant disclosure provides a single electrode layered capacitive touch-control device and a panel module thereof each capable of enhancing the edge touch accuracy and improving the capacitance distribution of the panel module.

The single electrode layered capacitive touch-control device comprises: a panel module comprising: a substrate having an inner surface and an opposite outer surface, wherein the inner surface is defined as a plurality of elongated touch-control segments, wherein the axis of elongation of each touch-control segment is parallel to a first direction; and a transparent electrode layer respectively patterned on the plurality of touch-control segments, wherein the transparent electrode layer on each respective touch-control segment comprises: a continuous coupling electrode having an axis of extension substantially parallel to the first direction, the coupling electrode separating the touch-control segment into a first-side region and a second-side region, wherein the first-side region and the second-side region respectively locate at two opposite sides of the coupling electrode; a plurality of first electrodes spacedly disposed on the first-side region of the touch-control segment electrically insulated from the coupling electrode and configured to generate mutual capacitance there-with; and a plurality of second electrodes spacedly disposed on the second-side region of the touch-control segment electrically insulated from the coupling electrode configured to generate mutual capacitance there-with; wherein any two adjacent coupling electrodes disposed on the corresponding touch-control segments are spacedly configured and electrically insulated from each other; and a circuit module comprising: a plurality of coupling lines, each of which having one end connected to a respective coupling electrode; a plurality of first conductive lines disposed the corresponding first-side region, each of which having one end connected to a corresponding first electrode; and a plurality of second conductive lines disposed on the corresponding second-side region, each of which having one end connected to a corresponding second electrode.

Preferably, at any three adjacent touch-control segments, the first electrode and the second electrode, which are disposed on the middle touch-control segment, are respectively facing the first electrode, which is disposed on the other touch-control segment, and the second electrode, which is disposed on another touch-control segment.

Preferably, at any three adjacent touch-control segments, the first electrode, which is disposed on the middle touch-control segment and arranged away from the hub circuit, and the first electrode, which is disposed on the other touch-control segment and arranged away from the hub circuit, are connected to the same first conductive line, and wherein the second electrode, which is disposed on the middle touch-control segment and arranged away from the hub circuit, and the second electrode, which is disposed on another touch-control segment and arranged away from the hub circuit, are connected to the same second conductive line.

The panel module of a single electrode layered capacitive touch-control device, the panel module comprises: a substrate having an inner surface and an opposite outer surface, wherein the inner surface is defined as a plurality of elongated touch-control segments, wherein the axis of elongation of each touch-control segment is parallel to a first direction; and a transparent electrode layer respectively patterned on the plurality of touch-control segments, wherein the transparent electrode layer on each respective touch-control segment comprises: a continuous coupling electrode having an axis of extension substantially parallel to the first direction, the coupling electrode separating the touch-control segment into a first-side region and a second-side region, wherein the first-side region and the second-side region respectively locate at two opposite sides of the coupling electrode; a plurality of first electrodes spacedly disposed on the first-side region of the touch-control segment electrically insulated from the coupling electrode and configured to generate mutual capacitance there-with; and a plurality of second electrodes spacedly disposed on the second-side region of the touch-control segment electrically insulated from the coupling electrode configured to generate mutual capacitance there-with; wherein any two adjacent coupling electrodes disposed on the corresponding touch-control segments are spacedly configured and electrically insulated from each other, and wherein a portion of the transparent electrode layer disposed on any two adjacent touch-control segments are configured in a mirror symmetry arrangement.

Base on the above, the first electrodes and the second electrodes are respectively located at two opposite sides of each coupling electrode at each touch-control segment, so that the left-most portion and the right-most portion of the substrate are configured to provide the uniform arrangement of the first conductive lines, thereby effectively enhancing the edge touch accuracy.

Moreover, the portion of the transparent electrode layer disposed on any two adjacent touch-control segments are configured in the mirror symmetry arrangement, so that the first and the second conductive lines and the adjacent coupling electrode are spacedly configured for preventing the first and the second conductive lines from electric coupled by the adjacent coupling electrode, thereby improving the capacitance distribution of the panel module.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a planar perspective view showing a single electrode layered conventional capacitive touch-control device;

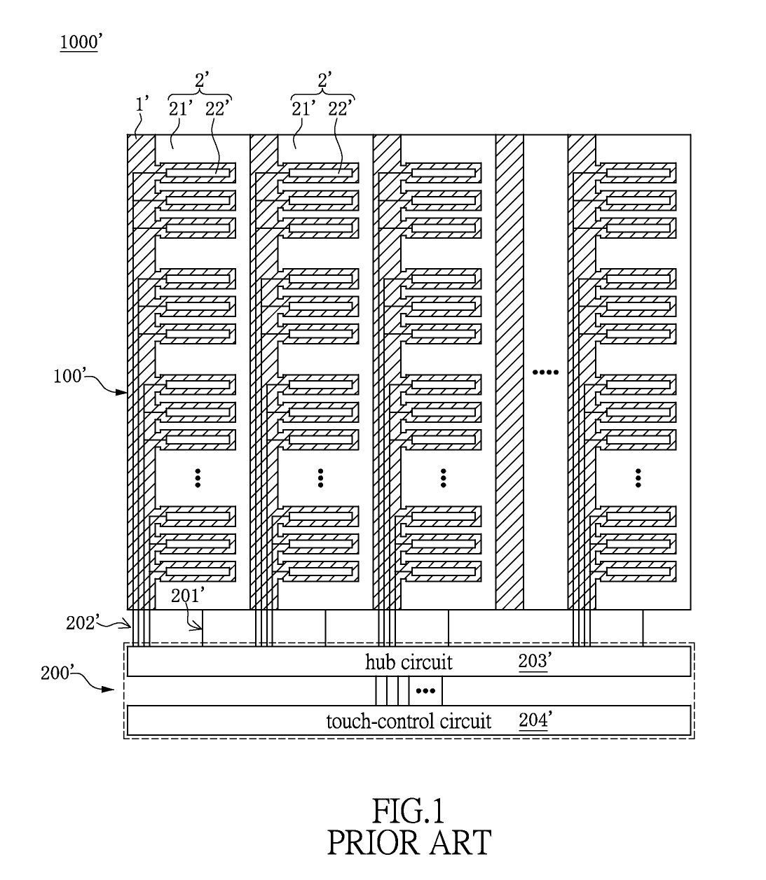

FIG. 2 is a planar perspective view showing a single electrode layered capacitive touch-control device of a first embodiment of the instant disclosure;

FIG. 3 is a cross-sectional view of FIG. 2;

FIG. 4 is a perspective view showing another state of the first embodiment of the instant disclosure;

FIG. 5 is a perspective view showing still another state of the first embodiment of the instant disclosure;

FIG. 6 is a planar perspective view showing the single electrode layered capacitive touch-control device of a second embodiment of the instant disclosure;

FIG. 7 is a perspective view showing another state of the second embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

### First Embodiment

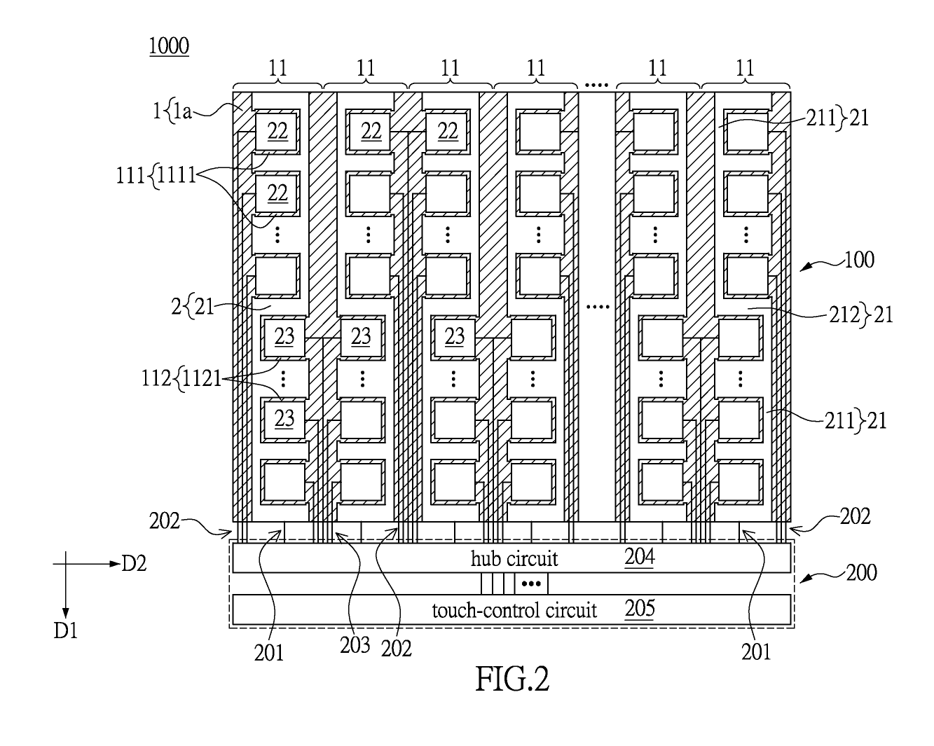

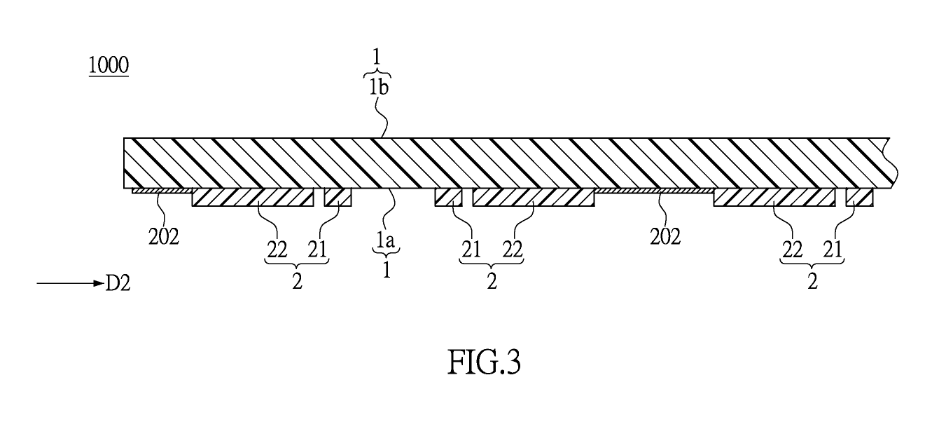

Please refer to FIGS. 2 and 3, which show a first embodiment of the instant disclosure. The instant embodiment provides a single electrode layered capacitive touch-control device 1000 including a panel module 100 and a circuit module 200. The panel module 100 has a substrate 1 and a transparent electrode layer 2 disposed on the substrate 1.

The substrate 1 has an inner surface 1a and an opposite outer surface 1b. The substrate 1 is configured to protect and carry each element disposed on the inner surface 1a, and the outer surface 1b is configured to provide a touch-control interface by a finger or a touch-control pen. A functional layer (e.g., anti-reflective layer or anti-dirt layer) can be coating on the outer surface 1b of the substrate 1 according to users' demand. The substrate 1 is a transparent plate, which is made of glass having a heat resistance of at least 1000° C., but the material of the substrate 1 is not limited to the instant embodiment. For example, the substrate 1 can be made of the insulating plastic (e.g., polyethylene) having a good transparency.

Specifically, the substrate 1 of the instant embodiment takes a rectangular plate for example, and the substrate 1 defines a first direction D1 and a second direction D2 perpendicular to the first direction D1, in which the first direction D1 is parallel to the longer edge of the substrate 1, the second direction D2 is parallel to the shorter edge of the substrate 1, but not limited to the instant embodiment. Moreover, the inner surface 1a is defined as a plurality of elongated touch-control segments 11 arranged in sequence along the second direction D2, and the axis of elongation of each touch-control segment 11 is parallel to the first direction D1.

The transparent electrode layer 2 is made of transparent conductive material, such as Indium Tin Oxide (ITO), Indium Zinc Oxide (IZO), Antimony doped Tin Oxide (ATO), or Alumina. Moreover, the transparent electrode layer 2 is separated into a plurality of segments respectively disposed on the touch-control segments 11 of the substrate 1. The following description main states one of the segments of the transparent electrode layer 2 and states the relationship between the segments of the transparent electrode layer 2 at suitable time for clearly explaining the construction of the transparent electrode layer 2.

Each segment of the transparent electrode layer 2 has a continuous coupling electrode 21, a plurality of first electrodes 22, and a plurality of second electrodes 23, in which the first and the second electrodes 21, 22 are spacedly arranged with and electrically insulated from the coupling electrode 21.

Each coupling electrode 21 is integrally formed in one piece and disposed on the touch-control segment 11. Each coupling electrode 21 has an axis of extension substantially parallel to the first direction D1. Specifically, each coupling electrode 21 has two longitudinal portions 211 and a plurality of transversal portions 212, in which each longitudinal portion 211 is parallel to the first direction D1, and the transversal portions 212 are respectively parallel to the second direction D2 and arranged along the first direction D1. The adjacent ends of the longitudinal portions 211 are coupled by two opposite ends of the transversal portion 212 located at the center of the transversal portions 212, and one end of each of the other transversal portions 212 is connected to the adjacent longitudinal portion 211.

Additionally, each touch-control segment 11 is divided into a first-side region 111 and a second-side region 112 by the corresponding coupling electrode 21, and the first-side region 111 and the second-side region 112 are located at two opposite sides of the coupling electrode 21. For example, please refer to the first touch-control segment 11 counted from the left (e.g., the left-most touch-control segment 11) as shown in FIG. 2, the first-side region 111 is located at the left side of the left edge of the coupling electrode 21, and the second-side region 112 is located at the right side of the right edge of the coupling electrode 21. Please refer to the second touch-control segment 11 counted from the left as shown in FIG. 2, the first-side region 111 is located at the right side of the right edge of the coupling electrode 21, and the second-side region 112 is located at the left side of the left edge of the coupling electrode 21.

Specifically, the first-side region 111 is defined with a plurality of first accommodating portions 1111 by the upper longitudinal portion 211 as shown in FIG. 2 and the transversal portions 212 connected to the upper longitudinal portion 211. The first accommodating portions 1111 are facing to the same direction. The second-side region 112 is defined with a plurality of second accommodating portions 1121 by the lower longitudinal portion 211 as shown in FIG. 2 and the transversal portions 212 connected to the lower longitudinal portion 211. The second accommodating portions 1121 are facing to the same direction, and the first accommodating portions 1111 and the second accommodating portions 1121 are respectively facing to opposite directions.

The first electrodes 22 are respectively disposed on the first accommodating portions 1111, and any two adjacent first electrodes 22 are spacedly configured, that is to say, the first electrodes 22 are arranged in a space surroundingly defined by the coupling electrode 21. The first electrodes 22 and the coupling electrode 21 are configured to generate mutual capacitance there-with. The second electrodes 23 are respectively disposed on the second accommodating portions 1121, and any two adjacent second electrodes 23 are spacedly configured, that is to say, the second electrodes 23 are arranged in a space surroundingly defined by the coupling electrode 21. The second electrodes 23 and the coupling electrode 21 are configured to generate mutual capacitance there-with.

Specifically, the first electrodes 22 are arranged substantially along the first direction D1, and the second electrodes 23 are arranged behind the first electrodes 22 along the first direction D1. In other words, each coupling electrode 21 has a plurality of first notches formed on a lateral portion thereof and a plurality of second notches formed on an opposite lateral portion thereof. Each first notch and each second notch are respectively facing to two opposite direction. The first electrodes 22 are respectively arranged in the first notches, and the second electrodes 23 are respectively arranged in the second notches.

The above description has been stated the construction of each segment of the transparent electrode layer 2. When viewing the whole transparent electrode layer 2, any two adjacent segments of the transparent electrode layer 2 are configured in a mirror symmetry arrangement, and the first electrodes 22 and the second electrodes 23 are configured in a matrix arrangement.

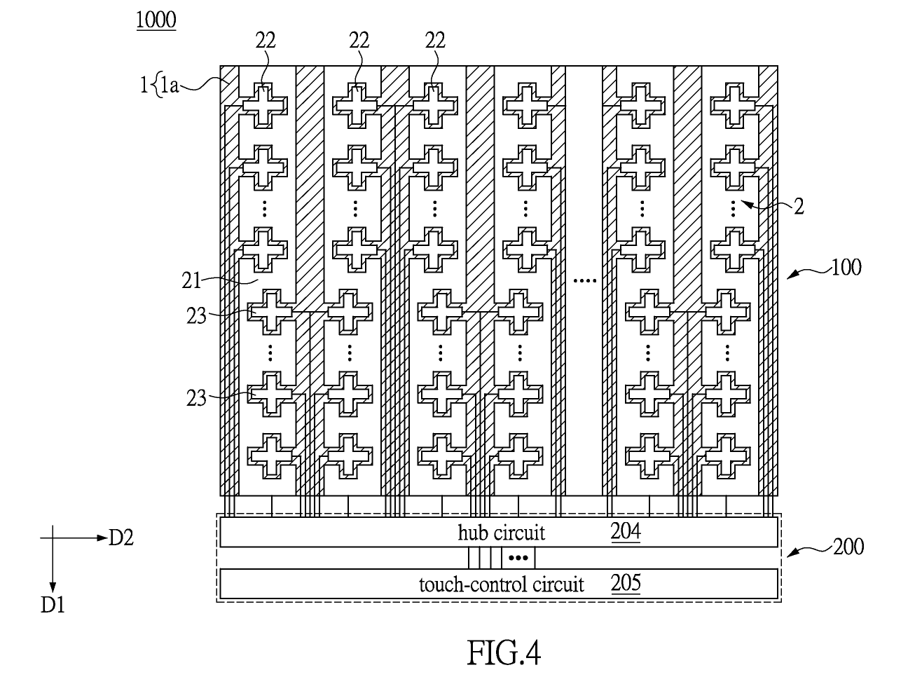

Incidentally, the first electrode 22 and the second electrode 23 in the instant embodiment each takes a square shape as shown in FIG. 2 for example, but are not limited to the instant embodiment. For example, the first electrode 22 and the second electrode 23 each can be a circular shape, a rectangular shape, a criss-cross shape as shown in FIG. 4, or the other suitable shape.

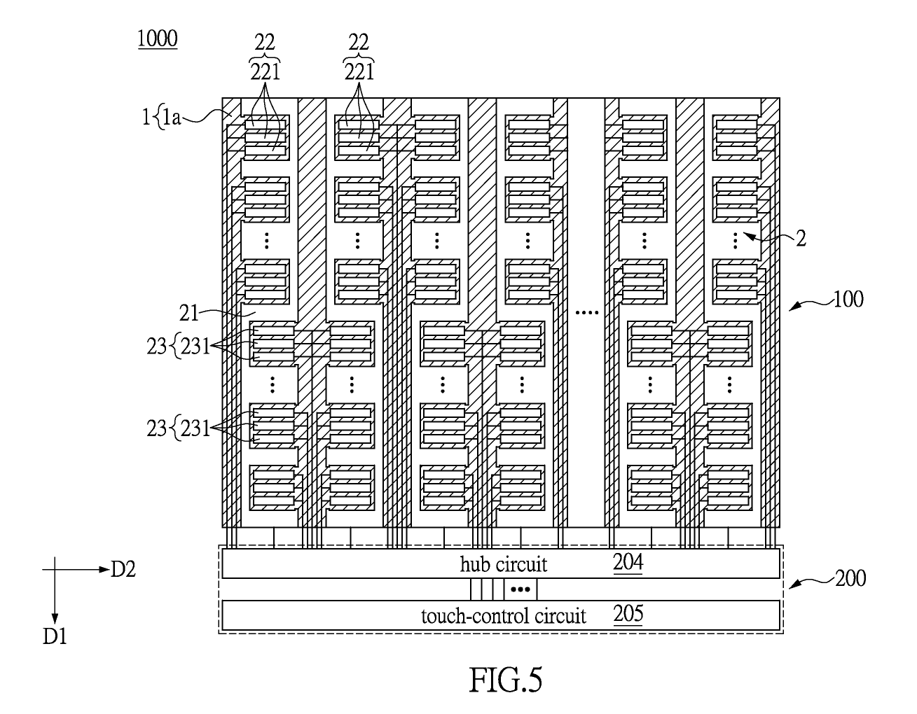

Additionally, each first electrode 22 and each second electrode 23 in the instant embodiment each takes one piece for example, but is not limited thereto. For example, please refer to FIG. 5, each first electrode 22 is consisted of three first sub electrodes 221 in parallel connection, and each second electrode 23 is consisted of three second sub electrodes 231 in parallel connection. The number of first sub electrode 221 of each first electrode 22 and the number of second sub electrode 231 of each second electrode 23 can be adjusted according to designer's demand, not limited to the instant embodiment.

Please to FIGS. 2 and 3. The circuit module 200 includes a plurality of coupling lines 201, a plurality of first conductive lines 202, a plurality of second conductive lines 203, a hub circuit 204, and a touch-control circuit 205. The hub circuit 204 and the touch-control circuit 205 are not the main improvement features and are the conventional means, so that the instant embodiment only takes the type of the hub circuit 204 and the touch-control circuit 205 as shown in figures for example, but not limited to the instant embodiment. That is to say, any kinds of the hub circuit and the touch-control circuit can be used for the single electrode layered capacitive touch-control device 1000.

One end of each coupling line 201 is connected to the corresponding coupling electrode 21, and another end of each coupling line 201 is connected to the hub circuit 204. One end of each first conductive line 202 is connected to the corresponding first electrode 22 and disposed on the corresponding first-side region 111, and another end of each first conductive line 202 is connected to the hub circuit 204. One end of each second conductive line 203 is connected to the corresponding second electrode 23 and disposed on the corresponding second-side region 112, and another end of each second conductive line 203 is connected to the hub circuit 204.

Thus, the instant disclosure improves the conventional problem of edge touch accuracy, which is generated by non-uniformly distribution of the conductive lines (e.g., one lateral portion of the substrate has too much conductive lines, and opposite lateral portion of the substrate does not have any conductive line). Specifically, the first electrodes 22 and the second electrodes 23 are respectively located at two opposite sides of each coupling electrode 21 at each touch-control segment 11, so that a left-most portion and a right-most portion of the substrate 1, which are respectively located outside the outermost coupling electrodes 21, are configured to provide the uniform arrangement of the first conductive lines 202, thereby effectively enhancing the edge touch accuracy of the capacitive touch-control device 1000.

Moreover, the instant disclosure improves the conventional problem of capacitance distribution of the conventional panel module, which is generated by the electric coupling between the conductive lines and the adjacent coupling electrode. Specifically, the first electrodes 22 and the second electrodes 23 are respectively located at two opposite sides of each coupling electrode 21 at each touch-control segment 11, and any two adjacent segments of the transparent electrode layer 2 are configured in the mirror symmetry arrangement, so that the first and the second conductive lines 202, 203 and the adjacent coupling electrode 21 are spacedly configured for preventing the first and the second conductive lines 202, 203 from electric coupled by the adjacent coupling electrode 21, thereby improving the capacitance distribution of the capacitive touch-control device 1000.

The hub circuit 204 is electrically connected to the touch-control circuit 205. The first conductive lines 202, which are connected to the first electrodes 22 of the same row, are electrically connected to each other or in short via the hub circuit 204. In other words, the first conductive lines 202, which are connected to the first electrodes 22 disposed on the different touch-control segments 11 and arranged along the second direction D2, are electrically connected to each other or in short. Moreover, the second conductive lines 203, which are connected to the second electrodes 23 of the same row, are electrically connected to each other or in short via the hub circuit 204. In other words, the second conductive lines 203, which are connected to the second electrodes 23 disposed on the different touch-control segments 11 and arranged along the second direction D2, are electrically connected to each other or in short. Accordingly, the hub circuit 204 may collect the sensing signals of the first and the second electrodes 22, 23 of the different touch-control segments 11 and transmit the sensing signals to the touch-control circuit 205 so as to proceed judgment of the touch-control position.

Thus, the capacitive touch-control device 1000 in the present disclosure may, efficiently reduce the number of pin used for making the first and the second conductive lines 202, 203 be connected to the touch-control circuit 205, reduce complexity of the circuit layout design and the layout space in demand, and thus the present disclosure may reduce a cost of design and manufacture.

Specifically, at any three adjacent touch-control segments 11 (e.g., the three touch-control segments 11 at the left portion of FIG. 2), the middle first electrodes 22 and the middle second electrodes 23, which are disposed on the middle touch-control segment 11, are respectively facing the lateral first electrode 22, which is disposed on the other touch-control segment 11(e.g., the right touch-control segment 11), and the lateral second electrode 23, which is disposed on another touch-control segment 11 (e.g., the left touch-control segment 11). Moreover, at any three adjacent touch-control segments 11(e.g., the three touch-control segments 11 at the left portion of FIG. 2), the first electrodes 22, which are respectively disposed on the middle touch-control segment 11 and the other touch-control segment 11 (e.g., the right touch-control segment 11) and are arranged away from the hub circuit 204, are connected to the same first conductive line 202; the second electrodes 23, which are disposed on the middle touch-control segment 11 and another touch-control segment 11 (e.g., the left touch-control segment 11) and are arranged away from the hub circuit 204, are connected to the same second conductive line 203.

The number of coupling line 201, the number of first conductive line 202, and the number of second conductive line 203 are explained by the following description. Firstly, defining the number of coupling electrode 21 is X, the number of first electrode 22 corresponding to each coupling electrode 21 is Y, and the number of second electrode 23 corresponding to each coupling electrode 21 is Z, in which X, Y, and Z are positive integer. When X is even as shown in FIG. 2, the number of coupling line 201 is X, the number of first conductive line 202 is XY−(X+2)/2, and the number of second conductive line 203 is XZ−(X/2), such that the number of first conductive line 202 with respect to the conventional number reduces (X+2)/2, and the number of second conductive line 203 with respect to the conventional number reduces X. When X is odd and not equal to one, the number of coupling line 201 is X, the number of first conductive line 202 is XY−(X−1)/2, and the number of second conductive line 203 is XZ−(X−1)/2, such that the number of first conductive line 202 with respect to the conventional number reduces (X−1)/2, and the number of second conductive line 203 with respect to the conventional number reduces (X−1)/2.

Base on the above, the face-to-face first electrodes 22, located away from the hub circuit 204 (e.g., the top face-to-face first electrodes 22 as shown in FIG. 2), are configured to share one first conductive line 202, thereby reducing the number of first conductive line 202, and the face-to-face second electrodes 22, located away from the hub circuit 204 (e.g., the top face-to-face second electrodes 23 as shown in FIG. 2), are configured to share one second conductive line 202, thereby reducing the number of second conductive line 203.

The above description has been stated the construction of the capacitive touch-control device 1000, and then the following description states the operating mean of the capacitive touch-control device 1000.

The touch-control circuit 205 sequentially transmits a plurality of driving scan signals SA₁˜SA_{M} respectively to the corresponding coupling electrodes 21 through the coupling lines 201 according to a plurality of predetermined scanning time t₁˜t_{M}. That is to say, please refer to FIG. 2, at the predetermined scanning time t₁, the touch-control circuit 205 transmits the driving scan signal SA₁ to the left-most coupling electrode 21 through the left-most coupling line 201; and at the predetermined scanning time t₂, the touch-control circuit 205 transmits the driving scan signal SA₂ to the second coupling electrode 21 counted from the left side through the corresponding coupling line 201. Similarly, at the predetermined scanning time t_{M}, the touch-control circuit 205 transmits the driving scan signal SA_{M} to the right-most coupling electrode 21 through the right-most coupling line 201. Accordingly, the touch-control circuit 205 may sense the coordinate of the touch point through scanning the whole capacitive touch-control device 1000.

When the voltage of at least one of the first and the second electrodes 22, 23 changes, the touch-control circuit 205 may sense voltage variation of each touch-control signal in the first and the second conductive lines 202, 203, and further acquire at least one coordinate of the touch point according to voltage variation of each touch-control signal in the first and the second conductive lines 202, 203 and the touch-control segments 11 corresponding to the predetermined scanning time t₁˜t_{M}. In short, the capacitive touch-control device 1000 of the instant disclosure not only senses single point touch-control, but also senses multi-point touch-control effectively.

For example, when a finger or a touch-control pen contacts the outer surface 1b of the capacitive touch-control device 1000, and the touch position of the outer surface 1b is corresponding to at least one of the first and the second electrodes 22, 23. The following description takes the touch position of the outer surface 1b corresponding to the left-most and the top first electrode 22 for example, the potential of the corresponding first electrode 22 may generate variation due to field coupling effect of the finger or the touch-control pen, so as to transmit the voltage variation of the touch-control signal of the corresponding first electrode 22 to the touch-control circuit 205 through the first conductive line 202 and the hub circuit 204.

Moreover, suppose the first direction D1 is Y-axis and the second direction D2 is X-axis hereinafter. The touch-control circuit 205 may acquire the Y coordinate of the touch position according to the relationship of electrically connection for the corresponding first electrode 22 in the touch-control circuit 205. The touch-control circuit 205 may further acquire the X coordinate of the touch position according to the predetermined scanning time t₁˜t_{M}, wherein the touch-control circuit 205 transmits the driving scan signals SA₁˜SA_{M} to drive the coupling electrodes 21 respectively through the coupling lines 201 according to the plurality of predetermined scanning time t₁˜t_{M} for distinguishing from the corresponding touch-control segments 11. In other words, the touch-control circuit 205 may transmit the driving scan signal SA₁ to the left-most coupling electrode 21 at the predetermined scanning time t₁ and sense the voltage variation of the touch-control signal of the left-most and the top first electrode 22. Therefore, the touch-control circuit 205 may precisely position and acquire touch coordinate of the touch point.

Incidentally, the coupling electrodes 21 in the instant embodiment are used as the driving electrodes, and the first and the second electrodes 22, 23 in the instant embodiment are used as the sensing electrodes, but the using manner of the coupling electrodes 21, the first electrodes 22, and the second electrodes 23 are not limited to the instant embodiment. For example, the coupling electrodes 21 can be used as the sensing electrodes, and the first and the second electrodes 22, 23 can be used as the coupling electrodes.

### Second Embodiment

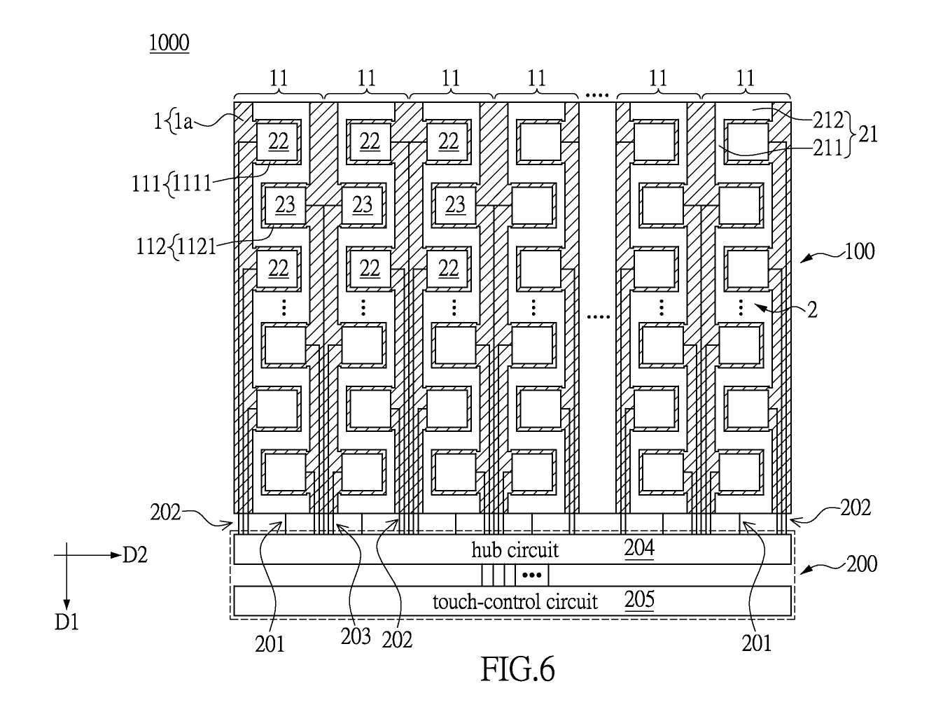

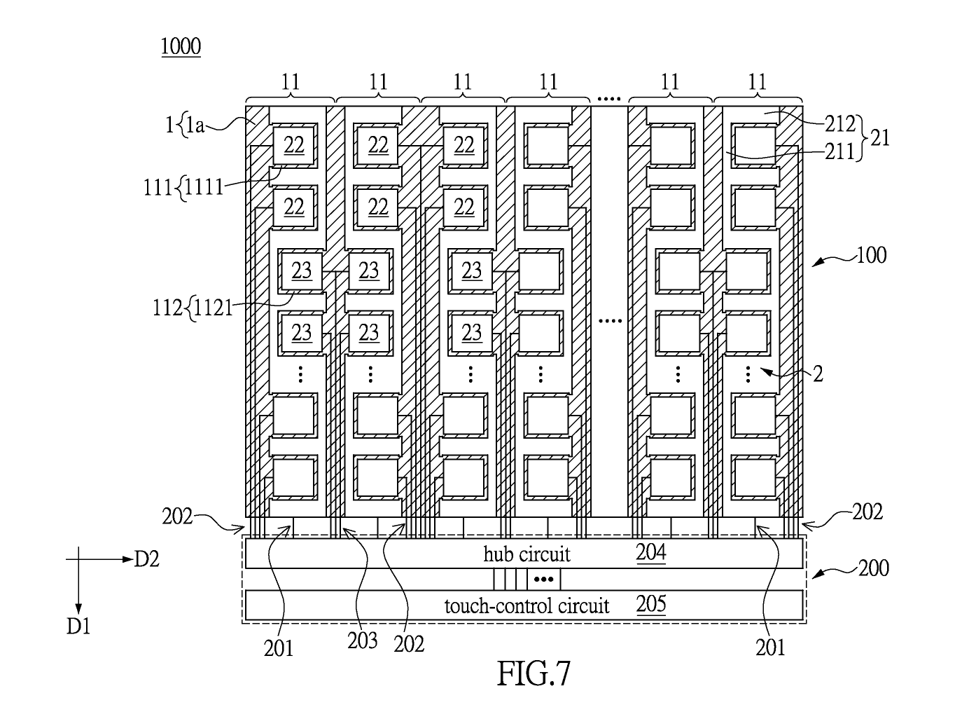

Please refer to FIGS. 6 and 7, which show a second embodiment of the instant disclosure. The instant embodiment is similar to the first embodiment, and the identical features do not state again. The difference between the instant embodiment and the first embodiment is the construction of the transparent electrode layer 2.

At each touch-control segment 11, the first electrode 22 and the second electrode 23 are alternatingly arranged along the first direction D1. As shown in FIG. 6, each coupling electrode 21 has a plurality of longitudinal portions 211 and a plurality of transversal portions 212, in which the longitudinal portions 211 are staggeredly arranged in two columns and each column is parallel to the first direction D1, and the transversal portions 212 are respectively parallel to the second direction D2. The adjacent ends of each two adjacent longitudinal portions 211 are coupled by two opposite ends of one transversal portion 212, so that the coupling electrode 21 has a plurality of S-shapes integrally connected in sequence along the second direction D2.

Specifically, at each touch-control segment 11, the first-side region 111 is defined with a plurality of first accommodating portions 1111 by the coupling electrode 21. The first accommodating portions 1111 are facing to the same direction. The second-side region 112 is defined with a plurality of second accommodating portions 1121 by the coupling electrode 21. The second accommodating portions 1121 are facing to the same direction, and the first accommodating portions 1111 and the second accommodating portions 1121 are facing to opposite directions. Moreover, each first accommodating portion 1111 or each second accommodating portion 1121 is defined by one longitudinal portion 211 and two connected transversal portions 212 connected to two ends of the longitudinal portion 211. That is to say, each second electrode 23 is located between any two adjacent first electrodes 22.

Besides, the instant embodiment takes the first electrode 22 and the second electrode 23 alternatingly arranged along the first direction D1 as shown in FIG. 6 for example, but is not limited to FIG. 6. For example, a group of the first electrode 22 and a group of the second electrode 23 are alternatingly arranged along the first direction D1 at each touch-control segment 11, in which the group of the first electrode 22 has two first electrodes 22, the group of the second electrode 23 has two second electrodes 23. In other words, the first electrode 22 may take a predetermined number to be a group and the second electrode 23 may take a predetermined number to be a group, such that each group of first electrode 22 and each group of second electrode 23 can be in a alternating arrangement.

### [Possible Effect of the Instant Disclosure]

Base on the above, the first electrodes and the second electrodes are respectively located at two opposite sides of each coupling electrode at each touch-control segment, so that the left-most portion and the right-most portion of the substrate, which are respectively located outside the outermost coupling electrodes, are configured to provide the uniform arrangement of the first conductive lines, thereby effectively enhancing the edge touch accuracy of the capacitive touch-control device with signal electrode layer.

Moreover, any two adjacent segments of the transparent electrode layer are configured in the mirror symmetry arrangement, so that the first and the second conductive lines and the adjacent coupling electrode are spacedly configured for preventing the first and the second conductive lines from electric coupled by the adjacent coupling electrode, thereby improving the capacitance distribution of the capacitive touch-control device with signal electrode layer.

Additionally, the face-to-face first electrodes, located away from the hub circuit, are configured to share the first conductive line, thereby reducing the number of first conductive line, and the face-to-face second electrodes, located away from the hub circuit, are configured to share the second conductive line, thereby reducing the number of second conductive line.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A single electrode layered capacitive touch-control device, comprising:
a panel module comprising:
a substrate having an inner surface and an opposite outer surface, wherein the inner surface is defined as a plurality of elongated touch-control segments, wherein the axis of elongation of each touch-control segment is parallel to a first direction; and
a transparent electrode layer respectively patterned on the plurality of touch-control segments, wherein the transparent electrode layer on each respective touch-control segment comprises:
a continuous coupling electrode having an axis of extension substantially parallel to the first direction, the coupling electrode separating the touch-control segment into a first-side region and a second-side region, wherein the first-side region and the second-side region respectively locate at two opposite sides of the coupling electrode;
a plurality of first electrodes spacedly disposed on the first-side region of the touch-control segment electrically insulated from the coupling electrode and configured to generate mutual capacitance there-with; and
a plurality of second electrodes spacedly disposed on the second-side region of the touch-control segment electrically insulated from the coupling electrode configured to generate mutual capacitance there-with;
wherein any two adjacent coupling electrodes disposed on the corresponding touch-control segments are spacedly configured and electrically insulated from each other; and
a circuit module comprising:
a plurality of coupling lines, each of which having one end connected to a respective coupling electrode;
a plurality of first conductive lines disposed the corresponding first-side region, each of which having one end connected to a corresponding first electrode; and
a plurality of second conductive lines disposed on the corresponding second-side region, each of which having one end connected to a corresponding second electrode.

2. The single electrode layered capacitive touch-control device as claimed in claim 1, wherein the first electrodes and the second electrodes are arranged substantially along the first direction.

3. The single electrode layered capacitive touch-control device as claimed in claim 2, wherein at each touch-control segment, the first-side region is defined with a plurality of first accommodating portions by the corresponding coupling electrode, any two adjacent first accommodating portions are spacedly configured, the second-side region is defined with a plurality of second accommodating portions by the corresponding coupling electrode, any two adjacent second accommodating portions are spacedly configured, and the first electrodes are respectively disposed on the first accommodating portions, the second electrodes are respectively disposed on the second accommodating portions.

4. The single electrode layered capacitive touch-control device as claimed in claim 3, wherein at each touch-control segment, the first electrodes are arranged substantially along the first direction, and the second electrodes are arranged behind the first electrodes along the first direction.

5. The single electrode layer capacitive touch-control device as claimed in claim 3, wherein at each touch-control segment, the first electrode and the second electrode are alternatingly arranged along the first direction.

6. The single electrode layered capacitive touch-control device as claimed in claim 5, wherein at each touch-control segment, each second electrode is located between any two adjacent first electrodes.

7. The single electrode layered capacitive touch-control device as claimed in claim 1, wherein a portion of the transparent electrode layer disposed on any two adjacent touch-control segments are configured in a mirror symmetry arrangement.

8. The single electrode layered capacitive touch-control device as claimed in claim 7, wherein the circuit module further has a hub circuit located at one side of the transparent electrode layer, and wherein another ends of each coupling lines, each first conductive line, and each second conductive line are connected to the hub circuit.

9. The single electrode layered capacitive touch-control device as claimed in claim 8, wherein at any three adjacent touch-control segments, the first electrode and the second electrode, which are disposed on the middle touch-control segment, are respectively facing the first electrode, which is disposed on the other touch-control segment, and the second electrode, which is disposed on another touch-control segment.

10. The single electrode layered capacitive touch-control device as claimed in claim 9, wherein at any three adjacent touch-control segments, the first electrode, which is disposed on the middle touch-control segment and arranged away from the hub circuit, and the first electrode, which is disposed on the other touch-control segment and arranged away from the hub circuit, are connected to the same first conductive line, and wherein the second electrode, which is disposed on the middle touch-control segment and arranged away from the hub circuit, and the second electrode, which is disposed on another touch-control segment and arranged away from the hub circuit, are connected to the same second conductive line.

11. A panel module of a single electrode layered capacitive touch-control device, the panel module comprising:
a substrate having an inner surface and an opposite outer surface, wherein the inner surface is defined as a plurality of elongated touch-control segments, wherein the axis of elongation of each touch-control segment is parallel to a first direction; and
a transparent electrode layer respectively patterned on the plurality of touch-control segments, wherein the transparent electrode layer on each respective touch-control segment comprises:
a continuous coupling electrode having an axis of extension substantially parallel to the first direction, the coupling electrode separating the touch-control segment into a first-side region and a second-side region, wherein the first-side region and the second-side region respectively locate at two opposite sides of the coupling electrode;
a plurality of first electrodes spacedly disposed on the first-side region of the touch-control segment electrically insulated from the coupling electrode and configured to generate mutual capacitance there-with; and
a plurality of second electrodes spacedly disposed on the second-side region of the touch-control segment electrically insulated from the coupling electrode configured to generate mutual capacitance there-with;
wherein any two adjacent coupling electrodes disposed on the corresponding touch-control segments are spacedly configured and electrically insulated from each other, and wherein a portion of the transparent electrode layer disposed on any two adjacent touch-control segments are configured in a mirror symmetry arrangement.
